(19) United States
(12) Patent Application Publication
(10) Pub. No.: US 2022/0075942 A1
(43) Pub. Date: Mar. 10, 2022

(54) INFORMATION PROCESSING DEVICE AND NON-TRANSITORY COMPUTER READABLE MEDIUM

(71) Applicant: FUJIFILM BUSINESS INNOVATION CORP., Tokyo (JP)

(72) Inventors: Shotaro MISAWA, Kanagawa (JP); Tomoki TANIGUCHI, Kanagawa (JP); Tomoko OHKUMA, Kanagawa (JP)

(73) Assignee: FUJIFILM BUSINESS INNOVATION CORP., Tokyo (JP)

(21) Appl. No.: 17/173,749

(22) Filed: Feb. 11, 2021

(30) Foreign Application Priority Data
Sep. 9, 2020 (JP) 2020-151659

(51) Int. Cl. G06F 40/284; G06F 40/30; G06N 20/00; G06N 3/08

(52) U.S. Cl. CPC G06F 40/284; G06N 3/08; G06N 20/00; G06F 40/30

(57) ABSTRACT

An information processing device includes a processor configured to acquire provision information and subject information, the provision information being information related to at least one of a source that provides a sentence and a destination that indicates where the sentence is written, and the subject information being information related to a subject about which the sentence is generated, and estimate a sentence length for the subject associated with the provision information by inputting the acquired provision information and the acquired subject information into a length estimation model trained to learn the lengths of past sentences for subjects associated with past provision information and past subject information.

### CROSS-REFERENCE TO RELATED APPLICATIONS

This application is based on and claims priority under 35 USC 119 from Japanese Patent Application No. 2020-151659 filed Sep. 9, 2020.

### BACKGROUND

### (i) Technical Field

The present disclosure relates to an information processing device and a non-transitory computer readable medium.

### (ii) Related Art

Japanese Unexamined Patent Application Publication No. 2020-071677 discloses a training method in which a computer executes a process of combining a first score and a second score, the first score being output for each word in a dictionary of a model that accepts a training input text as input, and the second score being computed for each word in the dictionary of the model from the length of the word and the number of remaining characters until a upper character limit of an abstract is reached. The computer also executes a process of computing a distribution of a word generation probability on the basis of the combined score combining the first score and the second score for each word.

Sentences are created by sources, such as users and persons in charge of such work at companies, and the created sentences are used for a variety of destinations, such as product slogans, news articles, and social networking services. Recently, technologies that train an artificial intelligence (AI) with sentences created by sources and thereby cause the AI to generate sentences reflecting the features of each source (such as the words used, for example) have been developed.

### SUMMARY

Meanwhile, features in a sentence may be expressed as not only the words used but also the length of the sentence, and such features change depending on the source or the destination.

In the process of training and causing an AI to output sentences, in the case where the training reflects only the features of the words in the sentences, the features related to the length of sentences at the source or the destination may not be considered.

Aspects of non-limiting embodiments of the present disclosure relate to estimating the length of a sentence to output to reflect the features of the source or the destination.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to acquire provision information and subject information, the provision information being information related to at least one of a source that provides a sentence and a destination that indicates where the sentence is written, and the subject information being information related to a subject about which the sentence is generated, and estimate a sentence length for the subject associated with the provision information by inputting the acquired provision information and the acquired subject information into a length estimation model trained to learn the lengths of past sentences for subjects associated with past provision information and past subject information.

### BRIEF DESCRIPTION OF THE DRAWINGS

An exemplary embodiment of the present disclosure will be described in detail based on the following figures, wherein:

FIG. 1 is a configuration diagram illustrating an example of a hardware configuration of an information processing device according to an exemplary embodiment;

FIG. 2 is a block diagram illustrating an example of a functional configuration of an information processing device according to the exemplary embodiment;

FIG. 3 is a diagram illustrating an example of a sentence history information database according to the exemplary embodiment;

FIG. 4 is a data-flow diagram illustrating an example of the flow of processes during a training process according to the exemplary embodiment;

FIG. 5 is a schematic diagram illustrating an example of a neural network according to the exemplary embodiment;

FIG. 6 is a schematic diagram illustrating an example of a recurrent neural network using an encoder-decoder model according to the exemplary embodiment;

FIG. 7 is a data-flow diagram illustrating an example of the flow of processes during an estimation process according to the exemplary embodiment;

FIG. 8 is a flowchart illustrating an example of the flow of information processing during the training process according to the exemplary embodiment;

FIG. 9 is a flowchart illustrating an example of the flow of information processing during the estimation process according to the exemplary embodiment; and

FIG. 10 is a data-flow diagram illustrating an example of the flow of processes during an estimation process according to the exemplary embodiment; and

FIG. 11 is a data-flow diagram illustrating an example of the flow of processes during an estimation process accompanying a description of a noise generation unit according to an exemplary modification of the exemplary embodiment.

### DETAILED DESCRIPTION

Hereinafter, an exemplary embodiment for carrying out the present disclosure will be described in detail and with reference to the drawings.

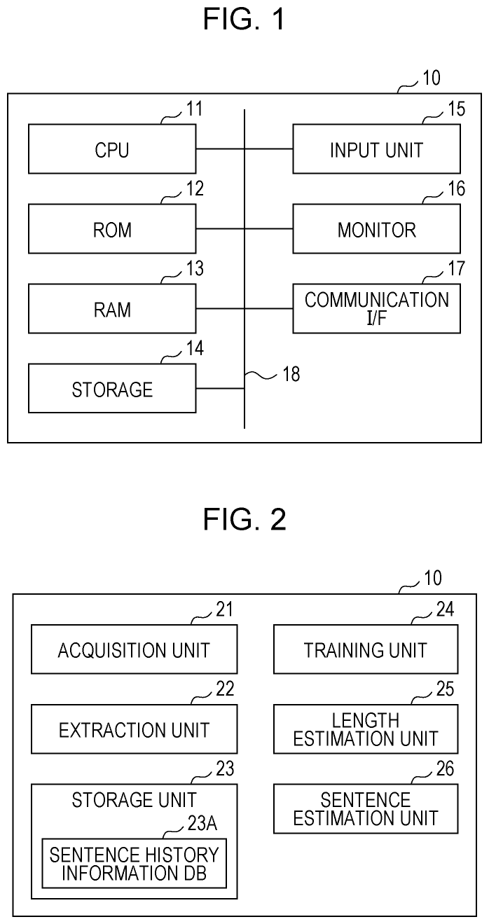

FIG. 1 will be referenced to describe the configuration of the information processing device 10. FIG. 1 is a block diagram illustrating an example of a hardware configuration of the information processing device 10 according to the exemplary embodiment. As an example, the information processing device 10 according to the exemplary embodiment is a terminal such as a personal computer, or is a server.

As illustrated in FIG. 1, the information processing device 10 according to the exemplary embodiment includes a central processing unit (CPU) 11, read-only memory (ROM) 12, random access memory (RAM) 13, storage 14, an input unit 15, a monitor 16, and a communication interface (communication I/F) 17. The CPU 11, the RAM 12, the ROM 13, the storage 14, the input unit 15, the monitor 16, and the communication I/F 17 are interconnected by a bus 18. Here, the CPU 11 is an example of a processor.

The CPU 11 centrally controls the information processing device 10 overall. The RAM 12 stores various programs, including an information processing program used in the exemplary embodiment, data, and the like. The ROM 13 is memory used as a work area when executing the various programs. The CPU 11 performs a process of generating sentences by loading a program stored in the RAM 12 into the ROM 13 and executing the program. The storage 14 is a component such as a hard disk drive (HDD), a solid-state drive (SSD), or flash memory, for example. Note that the information processing program and the like may also be stored in the storage 14. The input unit 15 includes devices such as a mouse and keyboard that receive text input and the like. The monitor 16 displays information such as generated sentences. The communication I/F 17 transmits and receives data.

Next, FIG. 2 will be referenced to describe a functional configuration of the information processing device 10. FIG. 2 is a block diagram illustrating an example of a functional configuration of the information processing device 10 according to the exemplary embodiment.

As illustrated in FIG. 2, the information processing device 10 is provided with an acquisition unit 21, an extraction unit 22, a storage unit 23, a training unit 24, a length estimation unit 25, and a sentence estimation unit 26. The CPU 11 executes the information processing program and thereby functions as the acquisition unit 21, the extraction unit 22, the storage unit 23, the training unit 24, the length estimation unit 25, and the sentence estimation unit 26.

The acquisition unit 21 acquires input information input by a user. Specifically, the acquisition unit 21 acquires information (hereinafter referred to as “provision information”) indicating a source that provides a sentence and a destination where the sentence is written, and information (hereinafter referred to as “subject information”) related to a subject about which the sentence is generated. Also, in the training process, the acquisition unit 21 acquires a sentence created by a user.

Note that the provision information according to the exemplary embodiment includes information about the source, such as a name of the user or a name of a company that created the sentence, and information about the destination (medium), such as a news article, a social networking service, or an academic journal where the sentence is written, for example. Additionally, the provision information may also include information that identifies the user (for example, a user identification (ID)) and information related to features of the user, such as the age, gender, and hobbies of the user as the information about the source. Additionally, the provision information may also include information that identifies the destination (for example, a destination ID) and details about the destination (for example, a name of the medium and the location (such as body text or title) where the sentence is written) as the destination information. Furthermore, the provision information may include information about a target of the medium (such as a target age and a target gender, for example), a date and time of publishing to the destination, and the like as the information about the destination. Also, the subject information according to the exemplary embodiment includes a subject indicated by the sentence, such as a product or a topic of conversation, for example. Also, a configuration is described in which the sentence according to the exemplary embodiment contains one or multiple grammatical sentences. However, the configuration is not limited thereto. The sentence is not limited to grammatical sentences punctuated by punctuation marks or the like, and may be written in any way insofar as the sentence is expressed using characters. Also, in the configuration described in the exemplary embodiment, the term “written” encompasses not only entering, recording, and presenting characters in a publication, document, or the like, but also recording an input sentence on a device such as a server, and presenting or publishing the sentence over the Internet.

In the training process, the extraction unit 22 extracts features of a sentence from a sentence input by a user. Specifically, the extraction unit 22 extracts the number of characters in the sentence (hereinafter referred to as the “sentence length”) from the input sentence. For example, in the case where “Now Hiring! Seeking engineer in charge of cutting-edge technology” is input as the sentence, the extraction unit 22 extracts “65 characters” as the sentence length from the input sentence. Note that a configuration is described in which the sentence length according to the exemplary embodiment is the number of characters in the sentence. However, the configuration is not limited thereto. The sentence length may also be the number of words or the number of clauses.

The storage unit 23 stores the provision information, the subject information, the sentence, and the extracted sentence length in association with each other as information (hereinafter referred to as “sentence history information”) indicating a history of sentences created by users in the past. The storage unit 23 stores the sentence history information in a sentence history information database (hereinafter referred to as the “sentence history information DB”) 23A.

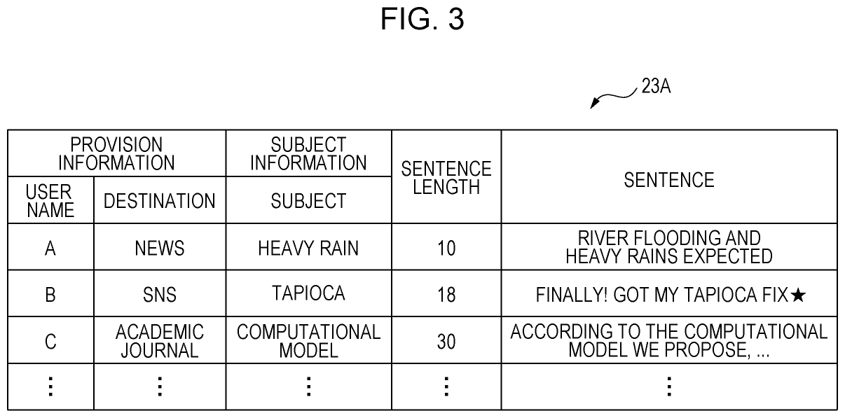

For example, as illustrated in FIG. 3, the sentence history information DB 23A stores the provision information, the subject information, the sentence length, and the sentence in association with each other. The provision information includes a username and a destination, and the subject information includes a subject. The username is a name of the user who created the sentence, and the destination is information indicating the medium where the sentence is written. The subject is information indicating a topic or theme of the sentence, while the sentence length is information indicating the length of the sentence, and the sentence is a sentence related to the subject created in the past by the user.

Note that a configuration is described in which the sentence length according to the exemplary embodiment is extracted from the sentence by the extraction unit 22. However, the configuration is not limited thereto. A sentence length input by the user may also be stored.

The training unit 24 uses the sentence history information stored in the sentence history information DB 23A to train the length estimation unit 25 and the sentence estimation unit 26. Specifically, the training unit 24 inputs provision information that includes at least one username and destination and subject information that includes a subject into the length estimation unit 25 as training data, and trains the length estimation unit 25 by using the sentence length associated with the training data as teaching data. Also, the training unit 24 inputs provision information that includes at least one username and destination, the subject information that includes a subject, and the sentence length in the sentence history information into the sentence estimation unit 26 as training data, and trains the sentence estimation unit 26 by using the sentence associated with the training data as teaching data.

The length estimation unit 25 uses the provision information and the subject information acquired by the acquisition unit 21 to estimate the sentence length of the sentence for the subject information associated with the provision information. Specifically, the length estimation unit 25 uses at least one of the username and the destination and also the subject to estimate the sentence length of the sentence related to the subject corresponding to at least one of the user and the destination. Here, the length estimation unit 25 is an example of a length estimation model.

The sentence estimation unit 26 uses the provision information acquired by the acquisition unit 21, the subject information acquired by the acquisition unit 21, and the sentence length estimated by the length estimation unit 25 to estimate a sentence (hereinafter referred to as the “subject sentence”) related to the subject information corresponding to the provision information and the sentence length. Specifically, the sentence estimation unit 26 uses at least one of the username and the destination, the subject, and sentence length to estimate a subject sentence related to the subject corresponding to at least one of the user and the destination, and the sentence length. Here, the sentence estimation unit 26 is an example of a sentence estimation model.

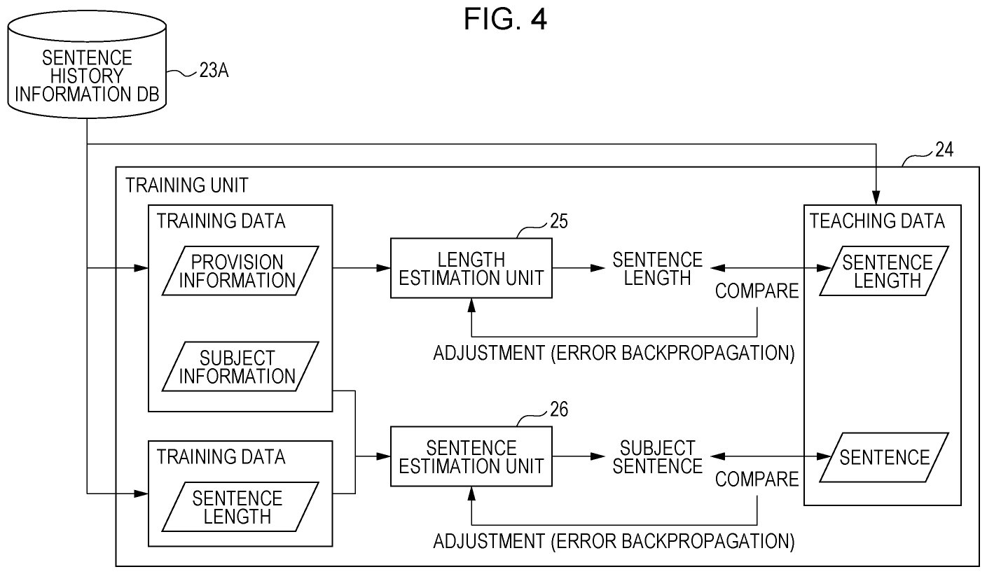

Next, before describing the action of the information processing device 10, FIGS. 4 to 7 will be referenced to describe a method of estimating the sentence length and the subject sentence according to the exemplary embodiment. FIG. 4 is a data-flow diagram illustrating an example of the flow of processes in an explanation of the training process according to the exemplary embodiment.

As an example, as illustrated in FIG. 4, in the process of training the length estimation unit 25 and the sentence estimation unit 26, the training unit 24 performs training by using the sentence history information stored in the sentence history information DB 23A as training data.

The training unit 24 performs batch training on the length estimation unit 25 using the provision information and the subject information acquired from the sentence history information DB 23A as training data and the sentence length acquired from the sentence history information DB 23A as teaching data. the length estimation unit 25 outputs a sentence length estimated from the training data containing the provision information and the subject information.

The length estimation unit 25 according to the exemplary embodiment performs a process using the input provision information and subject information as training data to estimate the sentence length. For example, the length estimation unit 25 estimates the sentence length with respect to the provision information and the subject information by using statistical regression analysis. In addition, the length estimation unit 25 trains by comparing the sentence length provided as teaching data to the estimated sentence length.

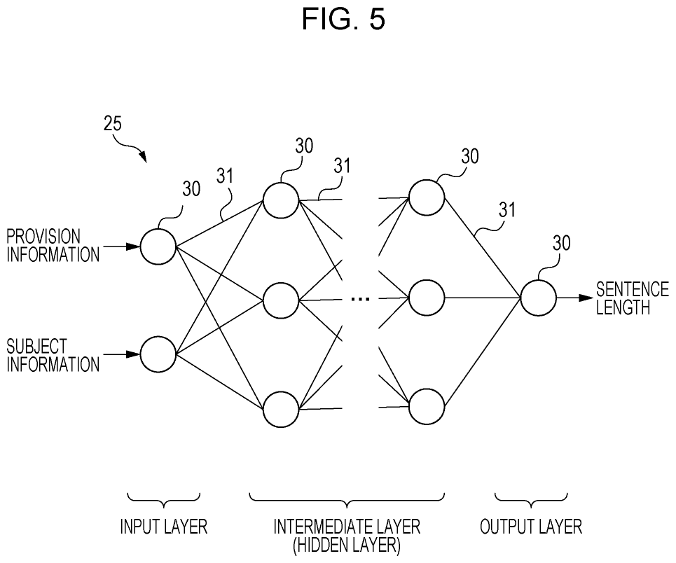

Here, the length estimation unit 25 and the sentence estimation unit 26 are learning models using a neural network. As illustrated in FIG. 5 as an example, the neural network has multiple layers of nodes 30 that perform processing in an input layer, intermediate layer (hidden layers), and an output layer. The nodes 30 in each layer are joined by edges 31, and the neural network performs processing by propagating data processed by each of the nodes 30 in order from the input layer, through the intermediate layers, to the output layer.

Also, as illustrated in FIG. 5, the sentence length is estimated by inputting the provision information and the subject information into the input layer of the length estimation unit 25. The length estimation unit 25 according to the exemplary embodiment estimates a sentence length having a single value, such as “6 characters”. However, the configuration is not limited thereto. Sentence lengths may also be categorized into classes having a sentence length range, such as “5 to 10 characters”, and the length estimation may estimate the class.

Also, the length estimation unit 25 uses error backpropagation to adjust each layer. Error backpropagation refers to a technique of deriving a loss function that computes the error between the output of the learning model and correct data, and updating weight parameters for the edges 31 that join each of the nodes 30 so as to minimize the value of the loss function.

For example, processing is performed by multiplying the weight parameters of the edges 31 by a value derived by each of the nodes 30, and passing the result to the next layer as input. In other words, because the output of any layer depends on the value output by the nodes 30 in the preceding layer and the weight parameters of the joining edges 31, the output of any layer is adjustable by updating the weight parameters for the edges 31 that join with the nodes 30 in the preceding layer. That is, error backpropagation is a technique of updating the weight parameters in the direction from the output to the input (in order from the output layer, through the intermediate layers, to the input layer) to adjust the output.

For example, a loss function is expressed by

$$L = \frac{1}{N} {( E - R )}^{2} \qquad ( 1 )$$

where L is the magnitude of the error derived by the loss function, N is the number of data points, E is the estimated length of the sentence length, and R is the sentence length of the teaching data.

As in the expression described above, a loss function that squares the difference between the sentence length estimated by the length estimation unit 25 and the sentence length in the teaching data is derived, and weight parameters are updated in the length estimation unit 25 so as to minimize the loss function. Note that the loss function in the exemplary embodiment is described as being the value obtained by squaring the difference between the estimated sentence length and the sentence length in the teaching data. However, the configuration is not limited thereto. In the case of training by using a large amount of data like in batch training, a loss function that totals the squared values of the difference between the sentence length in all of the training data and the sentence length of the teaching data may also be used. This arrangement keeps the weight parameters from being updated for every piece of training data, and also reduces dependency of the accuracy of the estimated sentence length on the order in which the training data is input.

Also, as illustrated in FIG. 4, the training unit 24 performs batch training on the sentence estimation unit 26 using the provision information, the subject information, and the sentence length acquired from the sentence history information DB 23A as training data and the sentences acquired from the sentence history information DB 23A as teaching data. The sentence estimation unit 26 outputs a subject sentence estimated from the training data containing the provision information, the subject information, and the sentence length.

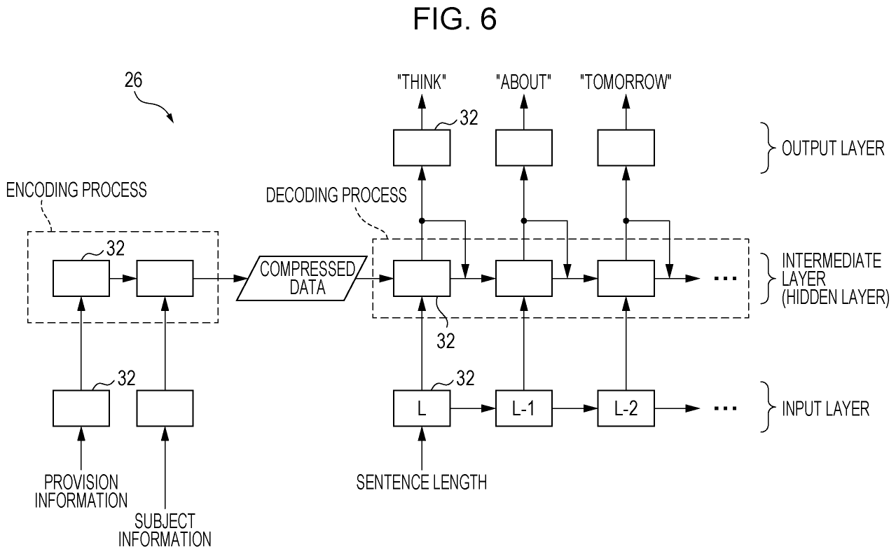

For example, as illustrated in FIG. 6, the sentence estimation unit 26 is a recurrent neural network using an encoder-decoder model. A recurrent neural network is used as a model for learning natural language, and in an intermediate layer, a recurrent neural network propagates processed data to different nodes 32 in the same layer for processing. Also, an encoder-decoder model is a model that performs, in an intermediate layer, an encoding process that extracts and compresses features from input training data into a vector of predetermined order and a decoding process that decodes words from the features included in the compressed data. A subject sentence is estimated by inputting provision information, subject information, and the sentence length into the sentence estimation unit 26 configured as a recurrent neural network using an encoder-decoder model.

By inputting the sentence length into the sentence estimation unit 26, a sentence is estimated with consideration for the length of the sentence. Specifically, as illustrated in FIG. 6, compressed data together with the sentence length is input into a node 32 in the decoding process, and 1 is subtracted from the input sentence length every time the node 32 generates a single character according to the decoding process. With this arrangement, the sentence estimation unit 26 is capable of estimating a sentence with consideration for the remaining number of characters in the decoding process.

The sentence estimation unit 26 is provided with dictionary data storing multiple predetermined words, and derives the likelihood of a word stored in the dictionary data by using compressed data obtained by compressing features of the input provision information and subject information as well as the immediately preceding output words. The sentence estimation unit 26 selects the word having the highest likelihood as the word to output next. The sentence estimation unit 26 repeats the above process of selecting a word until the length of the selected words exceeds the sentence length.

Note that a configuration is described in which the sentence estimation unit 26 according to the exemplary embodiment selects words from dictionary data to estimate a generation base from which to generate a sentence. However, the configuration is not limited thereto. The sentence estimation unit 26 may also estimate a search base from which to search for a sentence matching the conditions of the provision information, the subject information, and the sentence length input from previously input sentences as teaching data. Additionally, the sentence estimation unit 26 may also estimate a sentence by searching for a sentence matching the conditions and combining a search base with a generation base that replaces words in the selected sentence with words from the dictionary. Also, the sentence estimation unit 26 may select a sentence from among sentences pre-created by a user, or select a sentence from among pre-created sentence and estimated sentences. Also, the exemplary embodiment describes a configuration that selects words from dictionary data. However, the configuration is not limited thereto. A usage frequency may also be stored for each word, and words having a high usage frequency may be selected with priority.

In addition, the sentence estimation unit 26 adjusts each layer by using error backpropagation, similarly to the length estimation unit 25. However, in the case of applying error backpropagation to a recurrent neural network, it may be necessary to consider not only the propagation to one layer back from any layer, but also the propagation from any node 32 to one node 32 back in the same intermediate layer. In other words, in the case where data propagates in order from the input layer, through the intermediate layers (for example, from a node A to a node B), to the output layer, the weight parameters are updated in order from the output layer, through the intermediate layers (for example, from the node B to the node A), to the input layer.

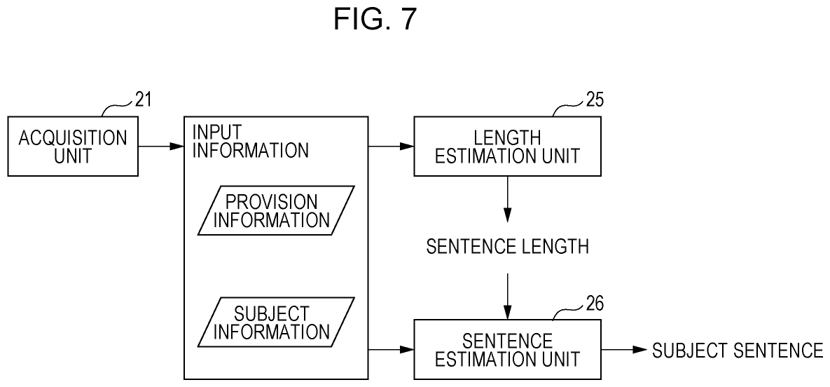

Next, FIG. 7 will be referenced to describe a technique of estimating the subject sentence according to the exemplary embodiment. FIG. 7 is a data-flow diagram illustrating an example of the flow of processes during an estimation process according to the exemplary embodiment.

For example, as illustrated in FIG. 7, the acquisition unit 21 acquires provision information and subject information input by the user, and the length estimation unit 25 uses the acquired provision information and subject information as input information to estimate the sentence length. The sentence estimation unit 26 uses the acquired provision information, the acquired subject information, and the estimated sentence length to estimate the subject sentence.

By causing the sentence estimation unit 26 to estimate the subject sentence using the sentence length estimated by the length estimation unit 25, a sentence related to the subject corresponding to the sentence length and the provision information is estimated.

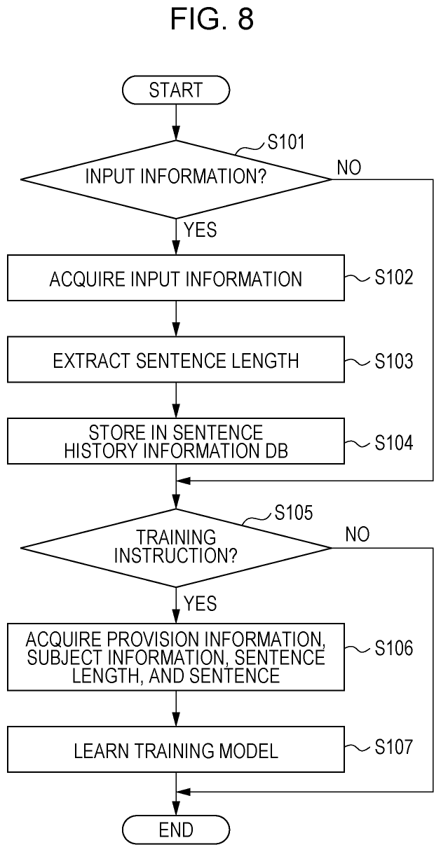

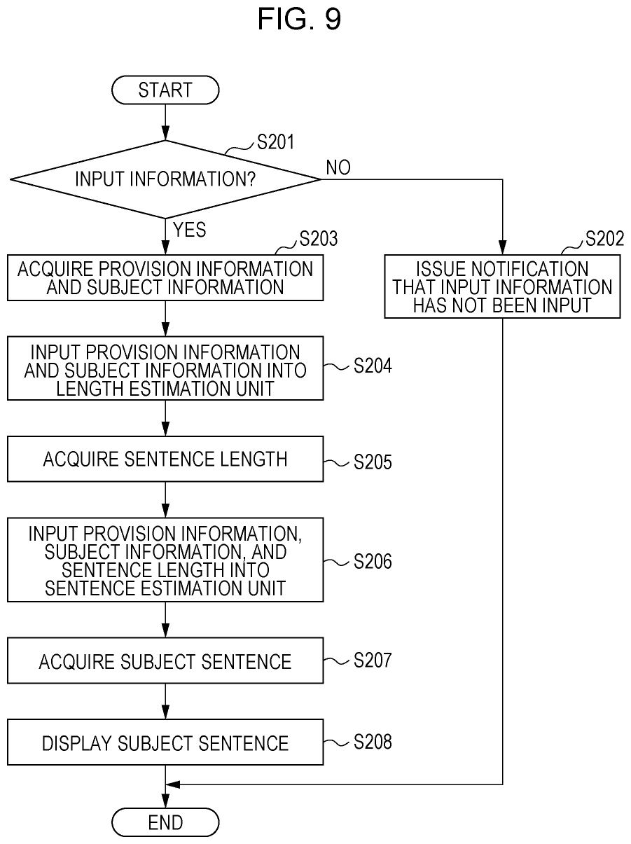

Next, FIGS. 8 and 9 will be referenced to describe the action of the information processing device 10 according to the exemplary embodiment. FIG. 8 is a flowchart illustrating an example of a training process according to the exemplary embodiment. The training program illustrated in FIG. 8 is executed by causing the CPU 11 to read out and execute a training program from the RAM 12 or the storage 14. The training program illustrated in FIG. 8 is executed in the case where input information including provision information, subject information, and a sentence is input by the user or in the case where a training instruction is input by the user, for example.

In step S101, the CPU 11 determines whether or not input information is input by the user. In the case where input information is input by the user (step S101: YES), the CPU 11 proceeds to step S102. On the other hand, in the case where input information is not input by the user (step S101: NO), the CPU 11 proceeds to step S105.

In step S102, the CPU 11 acquires input information including provision information, subject information, and a sentence.

In step S103, the CPU 11 extracts the sentence length from the acquired sentence.

In step S104, the CPU 11 stores the provision information, subject information, sentence length, and sentence in the sentence history information DB 23A.

In step S105, the CPU 11 determines whether or not a training instruction is input by the user. In the case where a training instruction is input (step S105: YES), the CPU 11 proceeds to step S106. On the other hand, in the case where a training instruction is not input (step S105: NO), the CPU 11 ends the training process.

In step S106, the CPU 11 acquires provision information, subject information, sentence lengths, and sentences included in the sentence history information from the sentence history information DB 23A.

In step S107, the CPU 11 uses the acquired provision information and subject information to train the length estimation unit 25 and the sentence estimation unit 26. Here, the CPU 11 performs training using the provision information and the subject information acquired from the sentence history information DB 23A as training data and the sentence lengths acquired from the sentence history information DB 23A as teaching data. Also, the CPU 11 performs training using the provision information, the subject information, and the sentence lengths acquired from the sentence history information DB 23A as training data and the sentences acquired from the sentence history information DB 23A as teaching data.

Next, FIG. 9 will be referenced to describe the action of an estimation process according to the exemplary embodiment. FIG. 9 is a flowchart illustrating an example of an estimation process according to the exemplary embodiment. The estimation program illustrated in FIG. 9 is executed by causing the CPU 11 to read out and execute an estimation program from the RAM 12 or the storage 14. The estimation program illustrated in FIG. 9 is executed in the case where input information including provision information and subject information is input by the user, and an instruction to estimate a subject sentence is input by the user, for example.

In step S201, the CPU 11 determines whether or not input information is input by the user. In the case where input information is input by the user (step S201: YES), the CPU 11 proceeds to step S203. On the other hand, in the case where input information is not input by the user (step S201: NO), the CPU 11 proceeds to step S202.

In step S202, the CPU 11 notifies the user that input information has not been input.

In step S203, the CPU 11 acquires provision information and subject information from the input information.

In step S204, the CPU 11 inputs the acquired provision information and subject information into the length estimation unit 25.

In step S205, the CPU 11 acquires a sentence length estimated from the provision information and the subject information.

In step S206, the CPU 11 inputs the acquired provision information, subject information, and sentence length into the sentence estimation unit 26.

In step S207, the CPU 11 acquires a subject sentence estimated from the provision information, the subject information, and the sentence length.

In step S208, the CPU 11 displays the acquired subject sentence.

As described above, according to the exemplary embodiment, the sentence length of a sentence related to subject information corresponding to provision information is estimated. Consequently, in the case of estimating a sentence, the feature of the length of the sentence corresponding to the source and the destination is reflected accurately.

### Exemplary Modifications

The exemplary embodiment above describes a configuration in which the length estimation unit 25 and the sentence estimation unit 26 each adjust the weight parameters individually in the training process. However, the configuration is not limited thereto. The length estimation unit 25 may also adjust the weight parameters by receiving a result adjusted by the sentence estimation unit 26.

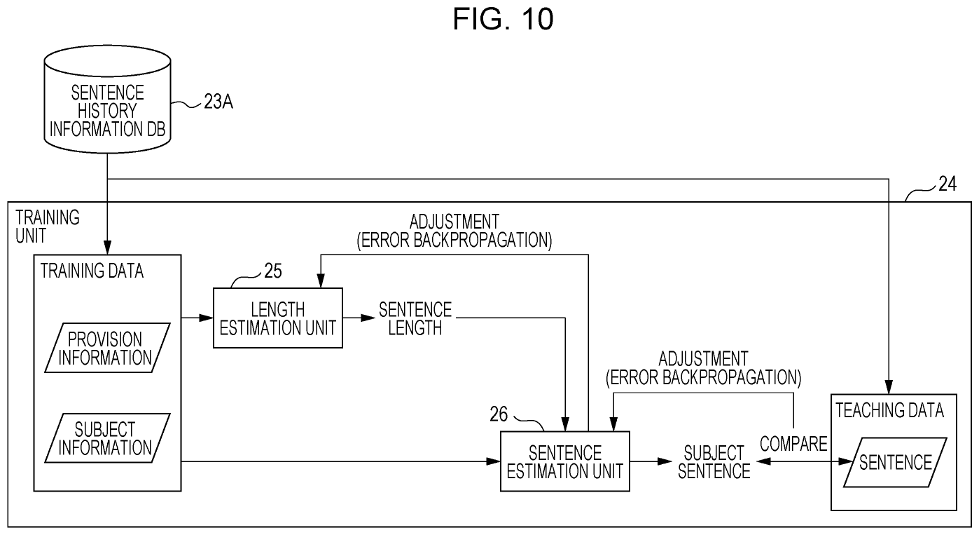

For example, as illustrated in FIG. 10, the length estimation unit 25 estimates the sentence length by treating the provision information and the subject information as input information, and the sentence estimation unit 26 estimates the subject sentence by treating the provision information, the subject information, and the sentence length estimated by the length estimation unit 25 as input information. The training unit 24 adjusts the weight parameters of the sentence estimation unit 26 by comparing the estimated subject sentence to a sentence in the correct data. In the case where the estimated sentence length is input into the sentence estimation unit 26 as input information, the training unit 24 uses error backpropagation to propagate the result adjusted by the sentence estimation unit 26 to the length estimation unit 25 and adjust the weight parameters of the length estimation unit 25. Note that in the case where the information propagated between the length estimation unit 25 and the sentence estimation unit 26 is discrete (not continuous), backpropagation may not be executed correctly. As an example, in the case where the fractional part of the sentence length “8.2” estimated by the length estimation unit 25 is truncated so that the sentence length input into the sentence estimation unit 26 is “8”, the propagated information becomes discrete, and backpropagation may not be executed correctly. To execute backpropagation correctly, there is a method of using Gumbel-Softmax and policy gradient methods for reinforcement learning or the like to make the information propagated between the length estimation unit 25 and the sentence estimation unit 26 continuous.

By receiving the result adjusted by the sentence estimation unit 26 in this way, the weight parameters of the length estimation unit 25 are adjusted in accordance with the result adjusted by the sentence estimation unit 26. Also, by adjusting the weight parameters of the length estimation unit 25 and the sentence estimation unit 26 on the same occasion, information is propagated more accurately than in the case of not adjusting the weight parameters, and the performance for estimating the sentence length and the sentence is improved.

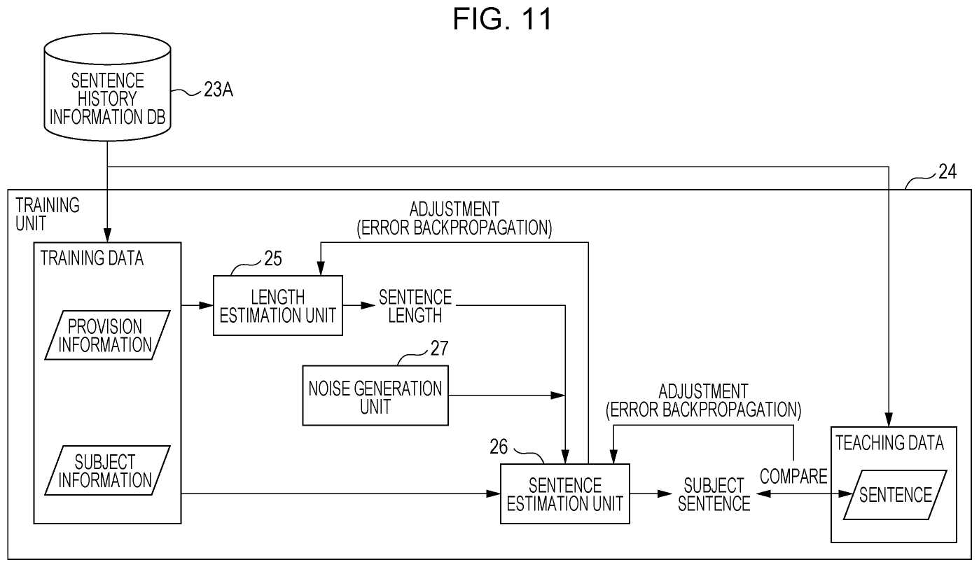

As another example, as illustrated in FIG. 11, in the case of performing training by inputting the sentence length estimated by the length estimation unit 25 into the sentence estimation unit 26, the information processing device 10 may be further provided with a noise generation unit 27 that adds noise to the estimated sentence length. FIG. 11 is a data-flow diagram illustrating an example of the flow of processes accompanying an explanation of the noise generation unit 27 according to the exemplary embodiment.

As illustrated in FIG. 11 for example, in the training process, the noise generation unit 27 corrects the sentence length by adding or subtracting an arbitrary sentence length with respect to the sentence length estimated by the length estimation unit 25. The sentence estimation unit 26 uses the provision information, the subject information, and the corrected sentence length to estimate the subject sentence. By correcting the estimated sentence length, a sentence of different length than the input sentence length is obtained in the process of training the sentence estimation unit 26, and as a result, the estimated sentence length may be changed flexibly.

Note that the arbitrary sentence length produced by the noise generation unit 27 may be predetermined by the user or selected randomly from a range predetermined by the user. Additionally, by causing the predetermined range to include 0, combinations of correct training data are learned.

Also, a configuration is described in which the length estimation unit 25 according to the exemplary embodiment above estimates one sentence length. However, the configuration is not limited thereto. The length estimation unit 25 may also estimate multiple sentence lengths, and may also estimate classes of sentence lengths classified by predetermined ranges.

For example, in the case of estimating multiple sentence lengths, the length estimation unit 25 may estimate a range of continuous lengths (such as from 5 to 7 characters, for example), or estimate discrete lengths. Also, in the case of estimating multiple discrete lengths, the length estimation unit 25 may select the longest sentence length and the shortest sentence length from among the multiple estimated sentence lengths to set and estimate a range of sentence lengths. Furthermore, the length estimation unit 25 may also estimate a single sentence length and then add or subtract a predetermined length with respect to the estimated sentence length to estimate multiple sentence lengths including the estimated length, the length after adding, and the length after subtracting. Here, the continuous lengths and the length range according to the exemplary embodiment are examples of multiple sentence lengths.

Also, in the case of estimating a range of sentence lengths, an expression like the following is used to adjust the weight parameters of the loss function in the error backpropagation.

L=λ₁(Eₘₐₓ−Eₘᵢₙ)+λ₂ MAX(R−Eₘₐₓ, 0)+λ₃ MAX(Eₘᵢₙ−R, 0) (2)

In the above expression, λ₁, λ₂, and λ₃ are balance coefficients of the loss functions, Eₘₐₓ is the maximum value of the estimated sentence length, and Eₘᵢₙ is the minimum value of the estimated sentence length. Also, MAX is a function that returns the largest of the given arguments as the return value. For example, MAX(R−Eₘₐₓ, 0) returns R−Eₘₐₓ in the case where R−Eₘₐₓ is greater than 0, and returns 0 in the case where R−Eₘₐₓ is less than 0.

In the case where the maximum value Eₘₐₓ of the estimated sentence length is larger than the sentence length R of the teaching data, the sentence length R of the teaching data is contained in the range estimated by the length estimation unit 25, and the sentence length is being estimated correctly. Consequently, the training unit 24 returns 0 as the return value, and does not influence the loss function. On the other hand, in the case where the maximum value Eₘₐₓ of the estimated sentence length is smaller than the sentence length R of the teaching data, the sentence length R is not contained in the range estimated by the length estimation unit 25, and the sentence length is not being estimated correctly. For this reason, the training unit 24 returns the difference between the sentence length R of the teaching data and the maximum value Eₘₐₓ of the estimated sentence length as the return value, and adds the return value to the loss function. Consequently, by using the above expression, whether or not the sentence length of the teaching data is contained in the range of the estimated sentence length is accounted for, and error backpropagation is used to adjust the weight parameters.

Note that in the case where the length estimation unit 25 estimates multiple sentence lengths, the sentence estimation unit 26 may estimate a subject sentence corresponding to one of the multiple sentence lengths, or estimate a subject sentence corresponding to each of the multiple sentence lengths. Also, in the case where the length estimation unit 25 estimates a range or class of sentence lengths, the sentence estimation unit 26 may estimate a subject sentence corresponding one sentence length included in the range or class, or estimate a subject sentence corresponding to each of the sentence lengths included in the range or class. Also, in the case of estimating multiple sentences, the sentence estimation unit 26 may select and output a single sentence from among multiple sentence candidates, or output multiple sentences as the estimated result.

Additionally, in the case of estimating a range or class of sentence lengths, the length estimation unit 25 may also learn a range or class of sentence lengths that includes the sentence lengths of the correct data. The range or class of sentence lengths learned by the length estimation unit 25 is derived from the sentence lengths of the correct data. For example, a range determined in advance from the sentence lengths may be treated as the range or class of sentence lengths to learn, or a randomly set range that includes the sentence lengths may be treated as the range or class of sentence lengths to learn.

Additionally, the length estimation unit 25 may also be trained by defining a range of sentence lengths having a random shortest length (hereinafter referred to as the “minimum length”) and longest length (hereinafter referred to as the “maximum length”) among the sentence lengths such that the sentence lengths of the correct data are included. By training with the training data in this way, the length estimation unit 25 learns the relationship between the correct length, the maximum length, and the minimum length, namely that the correct length is between the maximum length and the minimum length. If a maximum length and a minimum length are input into the length estimation unit 25 trained in this way, a sentence length between the maximum length and the minimum length is estimated.

By estimating multiple sentence lengths and multiple sentences, in sentence estimation, the possibility of estimating a variety of sentences may be considered, and the accuracy of estimating a more optimal sentence is improved.

Also, the above exemplary embodiment describes a configuration in which batch training is performed in the training process. However, the configuration is not limited thereto. Online training that trains with training data and teaching data one at a time may be performed, or data to train with may be chosen from among a large amount of training data, and mini-batch training that trains with a limited set of training data may be performed

Also, in the case where data sufficient to train the length estimation unit 25 is not obtained, the sentence length estimation by the length estimation unit 25 may not be performed, an average or median value of the sentence lengths for each user may be calculated as a representative value, and the representative value may be input into the sentence estimation unit 26.

Also, in the case of limiting the training data, the training may be limited by using statistics. Specifically, the training data may be condensed by calculating a representative value of data related to at least one of the user, the destination, and the subject. For example, in the case where many sentence lengths corresponding to the same user and the same subject exist in the sentence history information DB 23A, the sentence lengths associated with the same user and the same subject are acquired, and the average or median value of the acquired sentence lengths is calculated and treated as a representative value. The training unit 24 trains the length estimation unit 25 by treating the calculated representative value as a past sentence length corresponding to the same user and the same subject.

Additionally, in the case where the number of sentence lengths corresponding to the same user and the same subject stored in the sentence history information DB 23A is more than a predetermined number, the training unit 24 may perform the process of condensing the training data described above.

Also, a configuration is described in which the sentence history information DB 23A according to the exemplary embodiment stores provision information, subject information, and sentences input by the user. However, the configuration is not limited thereto. For example, information may be acquired over the Internet using a Web application programming interface (API) to acquire and collect provision information, subject information, and sentences. Additionally, sentences published on various websites may be acquired and collected over the Internet.

The above uses an exemplary embodiment to describe the present disclosure, but the present disclosure is not limited to the scope described in the exemplary embodiment. Various modifications or alterations may be made to the foregoing exemplary embodiment within a scope that does not depart from the gist of the present disclosure, and any embodiments obtained by such modifications or alterations are also included in the technical scope of the present disclosure.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

Also, the exemplary embodiment describes a configuration in which an information processing program is installed in the storage 14, but is not limited thereto. The information processing program according to the exemplary embodiment may also be provided by being recorded onto a computer-readable storage medium. For example, the information processing program according to an exemplary embodiment of the present disclosure may be provided by being recorded on an optical disc, such as a Compact Disc-Read-Only Memory (CD-ROM) or a Digital Versatile Disc-Read-Only Memory (DVD-ROM). Also, the information processing program according to an exemplary embodiment of the present disclosure may be provided by being recorded on semiconductor memory such as Universal Serial Bus (USB) memory or a memory card. Furthermore, the information processing program according to an exemplary embodiment of the present disclosure may also be acquired from an external device through a communication channel connected to the communication I/F 17.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to
acquire provision information and subject information, the provision information being information related to at least one of a source that provides a sentence and a destination that indicates where the sentence is written, and the subject information being information related to a subject about which the sentence is generated, and
estimate a sentence length for the subject associated with the provision information by inputting the acquired provision information and the acquired subject information into a length estimation model trained to learn the lengths of past sentences for subjects associated with past provision information and past subject information.

2. The information processing device according to claim 1, wherein
the processor is configured to estimate the sentence length by using statistics about the lengths of past sentences associated with past provision information and past subject information.

3. The information processing device according to claim 2, wherein
the processor is configured to estimate the sentence length from an average value of the lengths of past sentences associated with past provision information and past subject information.

4. The information processing device according to claim 1, wherein
the processor is configured to estimate the sentence length by adding or subtracting a predetermined sentence length with respect to a length of a sentence estimated by the length estimation model.

5. The information processing device according to claim 2, wherein
the processor is configured to estimate the sentence length by adding or subtracting a predetermined sentence length with respect to a length of a sentence estimated by the length estimation model.

6. The information processing device according to claim 3, wherein
the processor is configured to estimate the sentence length by adding or subtracting a predetermined sentence length with respect to a length of a sentence estimated by the length estimation model.

7. The information processing device according to claim 4, wherein
the predetermined sentence length is selected according to the source.

8. The information processing device according to claim 5, wherein
the predetermined sentence length is selected according to the source.

9. The information processing device according to claim 6, wherein
the predetermined sentence length is selected according to the source.

10. The information processing device according to claim 1, wherein
the sentence length is any one of a number of characters, a number of words, or a number of clauses.

11. The information processing device according to claim 2, wherein
the sentence length is any one of a number of characters, a number of words, or a number of clauses.

12. The information processing device according to claim 1, wherein
the provision information includes at least one of information related to a feature of the source, information related to a medium of the destination, and information related to a target at the destination.

13. The information processing device according to claim 1, wherein
the processor is configured to train the length estimation model by using a difference between the sentence length and the lengths of past sentences associated with past provision information and past subject information.

14. The information processing device according to claim 1, wherein
the processor includes a sentence estimation model that estimates a sentence, and
the processor is configured to estimate a subject sentence related to the subject corresponding to the sentence length and the provision information by inputting the acquired provision information, the acquired subject information, and the sentence length obtained from the length estimation model into the sentence estimation model.

15. The information processing device according to claim 14, wherein
the processor is configured to estimate a plurality of sentence lengths using the length estimation model, and estimate the subject sentence using the estimated plurality of sentence lengths.

16. The information processing device according to claim 15, wherein
the processor is configured to estimate the subject sentence corresponding to each of the plurality of sentence lengths.

17. The information processing device according to claim 16, wherein
the processor is configured to acquire a longest sentence length and a shortest sentence length from among the plurality of sentence lengths, and estimate the subject sentence corresponding to each of the sentence lengths included between the longest sentence length and the shortest sentence length.

18. The information processing device according to claim 14, wherein
the processor is configured to estimate a plurality of candidates for the subject sentence, and select the subject sentence from among the candidates.

19. The information processing device according to claim 14, wherein
the processor is configured to input past provision information, past subject information, and the lengths of past sentences into the sentence estimation model to train the sentence estimation model with sentences created in the past in the past provision information and the past subject information.

20. A non-transitory computer readable medium storing a program causing a computer to execute a process for processing information, the process comprising:
acquiring provision information and subject information, the provision information being information related to at least one of a source that indicates a user who generates a sentence and a destination that indicates where the sentence is written, and the subject information being information related to a subject about which the sentence is generated, and
estimating a sentence length for the subject associated with the provision information by inputting the acquired provision information and the acquired subject information into a length estimation model trained to learn the lengths of past sentences for subjects associated with past provision information and past subject information by inputting past provision information and past subject information into the length estimation model.
